(19) United States
(12) Patent Application Publication
(10) Pub. No.: US 2021/0242466 A1
(43) Pub. Date: Aug. 5, 2021

(54) NONAQUEOUS ELECTROLYTE SECONDARY BATTERY

(71) Applicant: TOYOTA JIDOSHA KABUSHIKI KAISHA, Toyota-shi (JP)

(72) Inventor: Masaki KATO, Toyota-shi (JP)

(73) Assignee: TOYOTA JIDOSHA KABUSHIKI KAISHA, Toyota-shi (JP)

(21) Appl. No.: 17/135,156

(22) Filed: Dec. 28, 2020

(30) Foreign Application Priority Data
Feb. 5, 2020 (JP) 2020-018234

(51) Int. Cl. H01M 4/62; H01M 10/0525; H01M 4/36; C01B 25/30

(52) U.S. Cl. CPC H01M 4/628; H01M 10/0525; H01M 2004/028; C01B 25/30; H01M 4/362

(57) ABSTRACT

The present disclosure provides a technology of eliciting the heat generation suppressing effect of trilithium phosphate (Li₃PO₄) in a 4 V class battery stably. The nonaqueous electrolyte secondary battery disclosed herein includes a positive electrode having a positive electrode mixture material layer, a negative electrode, and a nonaqueous electrolyte. The positive electrode has a region with an open voltage of 4.25 V (Li/Li⁺) or less in an operating range of the battery. The positive electrode mixture material layer includes a positive electrode active material, trilithium phosphate (Li₃PO₄), and lithium dihydrogenphosphate (LiH₂PO₄). In the nonaqueous electrolyte secondary battery disclosed herein, in an XRD pattern of the positive electrode mixture material layer, a peak intensity I_{A} detected near 27 cm⁻¹, and a peak intensity B detected near 22 cm⁻¹ satisfy 0<I_{A}/I_{B}≤0.03. This prevents decomposition of Li₃PO₄ and gelation of the positive electrode mixture material layer, and the heat generation suppressing effect by Li₃PO₄ can be stably elicited.

### CROSS REFERENCE TO RELATED APPLICATIONS

The present application claims the priority based on Japanese Patent Application No. 2020-18234 filed on Feb. 5, 2020, the entire contents of which are incorporated in the present specification by reference.

### BACKGROUND

### 1. Technical Field

The present disclosure relates to a nonaqueous electrolyte secondary battery.

### 2. Description of the Related Art

In recent years, a nonaqueous electrolyte secondary battery (e.g., a lithium ion secondary battery) has been used for a portable power source for a personal computer, a portable terminal, or the like; a vehicle driving power source for an electric vehicle (EV), a hybrid vehicle (HV), a plug-in hybrid vehicle (PHV) or other vehicles, or the like.

Generally, a nonaqueous electrolyte secondary battery has a configuration in which a positive electrode, a negative electrode, and a nonaqueous electrolyte are accommodated in a battery case. The positive electrode of such a nonaqueous electrolyte secondary battery includes a positive electrode collector, and a positive electrode mixture material layer including a positive electrode active material. In the nonaqueous electrolyte secondary battery having such a configuration, various additives are added to the positive electrode mixture material layer in order to improve battery performance. Examples of an additive to a positive electrode mixture material layer may include trilithium phosphate (Li₃PO₄). Japanese Patent Application Publication No. 2019-121561 discloses one example of a nonaqueous electrolyte secondary battery in which Li₃PO₄ is added to the positive electrode mixture material layer.

### SUMMARY

Incidentally, a battery having an open voltage within the operating range in normal use, which is 4.25 V or less on a metal lithium basis (Li/Li⁺) (also referred to as “4 V class battery”), has an advantage of high durability, and hence is widely used in various fields. However, such a 4 V class battery also has the property that a heating value in a negative electrode becomes large when over charge is caused.

In recent years, addition of Li₃PO₄ to the positive electrode mixture material layer has attracted attention as being effective to cope with the heat generation upon overcharging of the 4 V class battery. Specifically, when overcharge is caused in a 4 V class battery, at the surface of the positive electrode the electrolyte is decomposed, whereby hydrogen fluoride (HF) is generated. When Li₃PO₄ is present in the positive electrode mixture material layer at that time, HF and Li₃PO₄ react with each other and phosphate ions (PO₄³⁻) are generated. The PO₄³⁻ moves toward the negative electrode side and forms a phosphoric acid film on the surface of the negative electrode. This stabilizes the reaction on the negative electrode side, whereby heat generation is suppressed.

However, it is difficult to elicit this heat generation suppressing effect by Li₃PO₄ stably. Specifically, in a battery having the positive electrode mixture material layer added with Li₃PO₄, Li₃PO₄ may be decomposed, or the positive electrode mixture material layer may be gelled during normal charging and discharging. The occurrence of the phenomena may suppress the function of Li₃PO₄ from being properly exhibited, which may make it impossible to properly suppress the heat generation during overcharging. The present disclosure has been completed in order to solve such a problem and it is an object of the present disclosure to provide a technology of eliciting a heat generation suppressing effect of trilithium phosphate (Li₃PO₄) in a 4 V class battery stably.

In order to attain the object, the present disclosure provides a nonaqueous electrolyte secondary battery having a configuration below.

The nonaqueous electrolyte secondary battery disclosed herein includes a positive electrode having a positive electrode mixture material layer, a negative electrode, and a nonaqueous electrolyte. The positive electrode has a region with an open voltage of 4.25 V (Li/Li⁺) or less in the operating range of the battery is. Further, the positive electrode mixture material layer includes a positive electrode active material, trilithium phosphate (Li₃PO₄), and lithium dihydrogenphosphate (LiH₂PO₄). In the secondary battery disclosed herein, in an XRD pattern of the positive electrode mixture material layer, a peak intensity I_{A} detected in the vicinity of 27 cm⁻¹, and a peak intensity I_{B} detected in the vicinity of 22 cm⁻¹ satisfy expression (1) below:

0<I_{A}/I_{B}≤0.03 (1).

The present inventors conducted various experiments and studies in order to solve the problem. As a result, the present inventors found the following: when Li₃PO₄ and LiH₂PO₄ are allowed to coexist in the positive electrode mixture material layer, decomposition of Li₃PO₄ or gelation of the positive electrode mixture material layer is suppressed, which may stabilize the heat generation suppressing effect by Li₃PO₄. Then, the present inventors conducted a study on the conditions for causing the stabilization of the heat generation suppressing effect. As a result, it has been indicated as follows: with the positive electrode mixture material layer including Li₃PO₄ and LiH₂PO₄ coexisting therein, in analysis by X-ray diffraction (XRD), a peak A derived from LiH₂PO₄ occurs in the vicinity of 27 cm⁻¹, and a peak B derived from Li₃PO₄ occurs in the vicinity of 22 cm⁻¹. Then, the present inventors conducted a study on the effect on the heat generation suppressing effect given by the ratio I_{A}/I_{B} of the peak intensity I_{A} in the vicinity of 27 cm- to the peak intensity I_{B} in the vicinity of 22 cm⁻¹ (i.e., the abundance ratio of Li₃PO₄ and LiH₂PO₄ in the positive electrode mixture material layer). As a result, the present inventors found the following: when I_{A}/I_{B} satisfies the range of the expression (1) in a 4 V class battery, the heat generation suppressing effect by Li₃PO₄ is stabilized. The nonaqueous electrolyte secondary battery disclosed herein has been completed based on such findings.

Further, in accordance with one aspect of the nonaqueous electrolyte secondary battery disclosed herein, I_{A}/I_{B} is 0.008 or more. This can prevent the gelation of the positive electrode mixture material layer with reliability, and can further stabilize the heat generation suppressing effect by Li₃PO₄.

Still further, in accordance with another aspect of the nonaqueous electrolyte secondary battery disclosed herein, the content of trilithium phosphate is 1 wt % to 15 wt % for every 100 wt % of the total solid mass of the positive electrode mixture material layer. As a result, it is possible to obtain a 4 V class battery having high battery performances, and preferably suppressed in heat generation during overcharging.

### BRIEF DESCRIPTION OF THE DRAWINGS

FIG. 1 is a perspective view showing the outside shape of a lithium ion secondary battery in accordance with one embodiment of the present disclosure;

FIG. 2 is a perspective view schematically showing an electrode body of the lithium ion secondary battery in accordance with one embodiment of the present disclosure; and

FIG. 3 is a view showing the XRD pattern of the positive electrode mixture material layer of the lithium ion secondary battery in accordance with one embodiment of the present disclosure.

### DETAILED DESCRIPTION

Below, one embodiment of the present disclosure will be described with reference to the accompanying drawings. Incidentally, in the following accompanying drawings, the members/parts providing the same effect are given the same numerals and signs for description. Further, the dimensional relation (such as length, width, or thickness) in each drawing does not reflect the actual dimensional relation. Further, matters other than matters particularly mentioned in this specification, and required for practicing the present disclosure (e.g., the composition of a negative electrode or a general technology concerning construction of a nonaqueous electrolyte secondary battery) can be understood as the design matters of those skilled in the art based on the related art in the present field.

### 1. Lithium Ion Secondary Battery

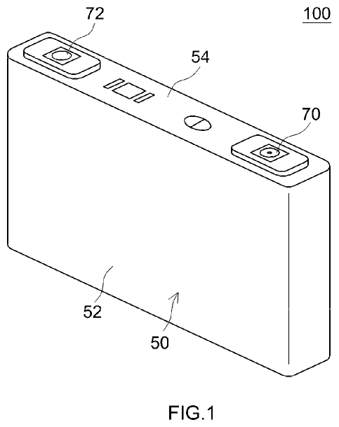

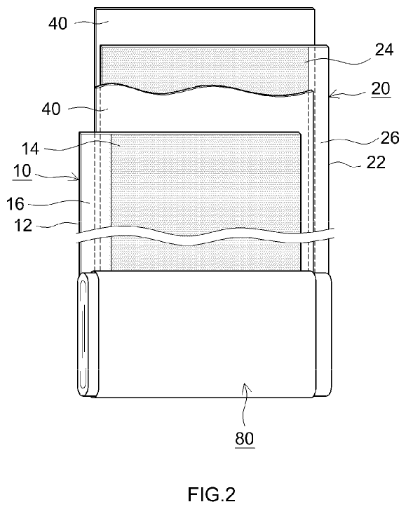

Below, a lithium ion secondary battery will be described as one example of the nonaqueous electrolyte secondary battery disclosed herein. FIG. 1 is a perspective view schematically showing the outside shape of a lithium ion secondary battery in accordance with the present embodiment. FIG. 2 is a perspective view schematically showing an electrode body of the lithium ion secondary battery in accordance with the present embodiment.

The lithium ion secondary battery shown in the present embodiment includes a positive electrode, a negative electrode, and a nonaqueous electrolyte. Specifically, as shown in FIGS. 1 and 2, the lithium ion secondary battery 100 includes an electrode body 80 having a positive electrode 10 and a negative electrode 20, and a nonaqueous electrolyte (not shown) accommodated in the inside of a battery case 50. Below, each configuration will be described.

### (1) Battery Case

As shown in FIG. 1, the battery case 50 has a flat rectangular case main body 52 with an opening formed in the upper surface thereof, and a lid body 54 for closing the opening of the upper surface. Further, the lid body 54 includes a positive electrode terminal 70 and a negative electrode terminal 72 mounted thereon. Although not shown, the positive electrode terminal 70 is connected with the positive electrode 10 of the electrode body 80 in the inside of the battery case 50, and is partially exposed to the outside of the battery case 50. On the other hand, the negative electrode terminal 72 is connected with the negative electrode 20 in the inside of the battery case 50, and is partially exposed to the outside of the battery case 50.

### (2) Electrode Body

As shown in FIG. 2, the electrode body 80 includes the positive electrode 10, the negative electrode 20, and a separator 40. The electrode body 80 in the present embodiment is a wound electrode body. Such a wound electrode body is formed in the following manner. A laminated body in which the positive electrode 10 and the negative electrode 20 each in a long sheet shape are stacked via the separator 40 is manufactured, and the laminated body is wound. Incidentally, for the structure of the electrode body in the technology disclosed herein, a conventionally known structure can be adopted without particular restriction, and the electrode body is not limited to the wound electrode body. Other examples of the structure of the electrode body may include a laminated electrode body in which a plurality of positive electrodes and negative electrodes are alternately stacked with separators interposed therebetween.

### (a) Positive Electrode

The positive electrode 10 includes a foil-shaped positive electrode collector 12, and a positive electrode mixture material layer 14 coated on each surface (each opposite surface) of the positive electrode collector 12. Further, a positive electrode exposed part 16 which is not coated with the positive electrode mixture material layer 14, and from which the positive electrode collector 12 is exposed is formed at one side edge in the width direction of the positive electrode 10. The positive electrode exposed part 16 is the region to be connected with a positive electrode terminal 70 (see FIG. 1). Then, the positive electrode mixture material layer 14 of the lithium ion secondary battery 100 in accordance with present embodiment includes a positive electrode active material, trilithium phosphate (Li₃PO₄), and lithium dihydrogenphosphate (LiH₂PO₄). The constituent components of such a positive electrode mixture material layer 14 will be described in details later.

### (b) Negative Electrode

The negative electrode 20 includes a foil-shaped negative electrode collector 22, and a negative electrode mixture material layer 24 coated on each surface (each opposite surface) of the negative electrode collector 22. Then, a negative electrode exposed part 26 which is not coated with the negative electrode mixture material layer 24, and from which the negative electrode collector 22 is exposed is formed at one side edge in the width direction of the negative electrode 20. The negative electrode exposed part 26 is electrically connected with a negative electrode terminal 72 (see FIG. 1).

The negative electrode mixture material layer 24 is a layer including a negative electrode active material as the main component. The negative electrode active material is a material capable of reversibly occluding and releasing electric charge carriers (e.g., lithium ions). For such negative electrode active materials, those for use in a general nonaqueous electrolyte secondary battery can be used without particular restriction. As an example thereof, for the negative electrode active material, graphite, non-graphitizable carbon (hard carbon), graphitizable carbon (soft carbon), or carbon nanotube, or a carbon material of a combination thereof can be used. Incidentally, from the viewpoint of the energy density, of the carbon materials, graphite type materials (such as natural graphite (plumbago) and artificial graphite) can be used. Further, the negative electrode mixture material layer 24 may also include additives (e.g., a binder and a thickener) therein other than the negative electrode active material. Examples of the binder may include styrene butadiene rubber (SBR). Further, examples of the thickener may include carboxymethyl cellulose (CMC). Incidentally, the additives also have no particular restriction, and general additives usable for the negative electrode mixture material layer can be used without particular restriction.

### (c) Separator

The separator 40 is a sheet-shaped member including an insulating resin. The separator 40 is interposed between the positive electrode 10 and the negative electrode 20, and prevents a short-circuit due to the direct contact therebetween. Further, the separator 40 includes a plurality of fine holes for allowing the electric charge carriers to pass therethrough formed therein. Transfer of electric charge carriers during charging and discharging is caused through the fine holes of the separator 40. For the separator 40, an insulating resin such as polyethylene (PE), polypropylene (PP), polyester, or polyamide can be used. Further, a laminated sheet obtained by stacking two or more layers of the resins is also acceptable. Examples of such a laminated sheet may include a three-layer sheet in which PP, PE, and PP are stacked in this order.

### (3) Nonaqueous Electrolyte

Further, in the battery case 50, a nonaqueous electrolyte is accommodated (filled) with the electrode body 80. For the nonaqueous electrolyte, the one obtained by allowing an organic solvent (nonaqueous solvent) to contain a support salt is used. As the nonaqueous solvents, for example, solvents of carbonates, ethers, esters, nitriles, sulfones, and lactones can be used without particular restriction. Specific examples of such a nonaqueous solvent may include ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), and trifluoro dimethyl carbonate (TFDMC). Further, for the support salt, a lithium salt containing fluorine is used. Examples of such a fluorine-containing lithium salt may include LiPF₆, LiBF₄, and LiCF₃SO₃. Incidentally, the concentration of the support salt in the nonaqueous electrolyte can be set at 0.75 mol/L to 1.25 mol/L (e.g., about 1 mol/L).

### 2. Constituent Components of Positive Electrode Mixture Material Layer

As described above, the positive electrode mixture material layer 14 of the lithium ion secondary battery 100 in accordance with the present embodiment includes a positive electrode active material, trilithium phosphate (Li₃PO₄), and lithium dihydrogenphosphate (LiH₂PO₄). Below, the constituent components of the positive electrode mixture material layer 14 will be described.

### (1) Positive Electrode Active Material

The positive electrode active material is a compound capable of reversibly occluding and releasing electric charge carriers. When lithium ions are used as electric charge carriers, as the positive electrode active material, an oxide including lithium and a transition metal element as constituent elements (lithium transition metal oxide) can be used. Incidentally, the lithium ion secondary battery 100 in accordance with the present embodiment is a 4 V class battery having a region in which the open voltage of the positive electrode 10 within the operating range of the battery is 4.25 V or less based on lithium (Li/Li⁺). For this reason, for the positive electrode active material, a material implementing an open voltage of 4.25 V or less in the positive electrode 10 is used. Examples of such a positive electrode active material for a 4 V class battery may include a lithium nickel cobalt manganese composite oxide having a layered crystal structure.

One example of the lithium nickel cobalt manganese composite oxide is shown in the following expression (2).

Li_{1+α}NiₓCo_{y}Mn_{(1-x-y)}M_{z}O_{2+β} (2)

α in the expression is −0.1≤α≤0.7. β is a value determined so as to satisfy the neutralization conditions of electric charges (typically, −0.5≤β, for example, −0.5≤β≤0.5). Further, “x” indicative of the Ni content is 0.1≤x≤0.9. “y” indicative of the Co content is 0.1≤y≤0.4. Further, M is another metal element except for Ni, Co, and Mn, and mention may be made of Zr, Mo, W, Mg, Ca, Na, Fe, Cr, Zn, Si, Sn, Al, or the like. “z” indicative of the content of the another metal element M is 0≤z≤0.1. Namely, the lithium nickel cobalt manganese composite oxide may or may not include another metal element M (0=z).

Incidentally, the battery performances tend to be improved with an increase in content of the positive electrode active material directly contributing to the charging and discharging reaction. From such a viewpoint, the content of the positive electrode active material for every 100 wt % of the total solid content mass of the positive electrode mixture material layer 14 can be set at 75 wt % or more, can be set at 80 wt % or more, can be set at 82 wt % or more, and can be set at 85 wt % or more. On the other hand, from the viewpoint of allowing the effects of the additives such as Li₃PO₄ and LiH₂PO₄ described later to be sufficiently exhibited, the upper limit value of the content ratio of the positive electrode active material can be set at 99 wt % or less, can be set at 97 wt % or less, can be set at 95 wt % or less, and can be set at 90 wt % or less.

### (2) Trilithium Phosphate

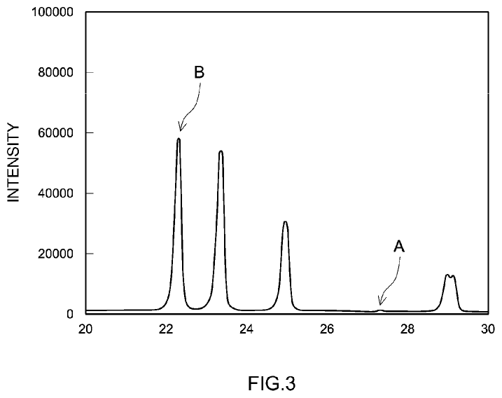

The positive electrode mixture material layer 14 in the present embodiment includes trilithium phosphate (Li₃PO₄). The Li₃PO₄ reacts with hydrogen fluoride (HF) generated by decomposition of the nonaqueous electrolyte during overcharging, resulting in phosphate ions (PO₄³⁻), which form a phosphoric acid film on the surface of the negative electrode 20. This stabilizes the charging and discharging reaction at the negative electrode 20, and hence can suppress the heat generation of the negative electrode 20 during overcharging. As shown in FIG. 3, when the positive electrode mixture material layer 14 containing Li₃PO₄ is subjected to X-ray diffraction (XRD), a peak B derived from Li₃PO₄ occurs in the vicinity of 22 cm⁻¹ (typically, 22±1 cm⁻¹). In the present specification, the intensity of the peak B derived from Li₃PO₄ is referred to as “peak intensity I_{B}”.

Incidentally, from the viewpoint of allowing the heat generation suppressing effect to be more preferably exhibited, the content of Li₃PO₄ for every 100 wt % of the total solid content mass of the positive electrode mixture material layer 14 can be set at 0.5 wt % or more, can be set at 0.75 wt % or more, can be set at 1 wt % or more, and can be set at 1.5 wt % or more. On the other hand, from the viewpoint of preventing the reduction of the battery performances due to the reduction of the content of the positive electrode active material, the upper limit value of the content of the Li₃PO₄ can be set at 15 wt % or less, can be set at 10 wt % or less, can be set at 7.5 wt % or less, and can be set at 5 wt % or less.

### (3) Lithium Dihydrogenphosphate

To the positive electrode mixture material layer 14 in the present embodiment, lithium dihydrogenphosphate (LiH₂PO₄) is added. As shown in FIG. 3, when the positive electrode mixture material layer 14 containing LiH₂PO₄ is subjected to XRD, a peak A derived from LiH₂PO₄ occurs in the vicinity of 27 cm⁻¹ (typically, 27±1 cm⁻¹). In the present specification, the intensity of the peak A derived from LiH₂PO₄ is referred to as “peak intensity I_{A}”. Then, in the present specification, the abundance proportions of Li₃PO₄ and LiH₂PO₄ in the positive electrode mixture material layer 14 are specified as “the ratio (I_{A}/I_{B}) of the peak intensity I_{A} derived from LiH₂PO₄ to the peak intensity In derived from Li₃PO₄”.

The experiments and the studies by the present inventors indicate as follows: when Li₃PO₄ and LiH₂PO₄ are allowed to coexist at proper proportions in the positive electrode mixture material layer 14, decomposition of Li₃PO₄ and gelation of the positive electrode mixture material layer 14 are suppressed, which stabilizes the heat generation suppressing effect due to Li₃PO₄. Specifically, when Li₃PO₄ and LiH₂PO₄ coexist in the positive electrode mixture material layer 14 (I_{A}/I_{B}>0), gelation of the positive electrode mixture material layer 14 is preferably suppressed. On the other hand, when the abundance proportion of LiH₂PO₄ to Li₃PO₄ is too large, decomposition of Li₃PO₄ may rather proceed. For this reason, in the present embodiment, the abundance proportion (I_{A}/I_{B}) of LiH₂PO₄ to Li₃PO₄ is adjusted at 0.03 or less. In other words, for the lithium ion secondary battery 100 in accordance with the present embodiment, the peak intensity I_{A} in the vicinity of 27 cm⁻¹ derived from Li₃PO₄, and the peak intensity I_{B} in the vicinity of 22 cm⁻¹ derived from LiH₂PO₄ satisfy the following expression (1) in the XRD pattern of the positive electrode mixture material layer 14. This can properly suppress the decomposition of Li₃PO₄ and the gelation of the positive electrode mixture material layer 14. For this reason, the heat generation suppressing effect of Li₃PO₄ can be preferably exhibited, which can preferably suppress the heat generation of a 4 V class battery during overcharging.

0<I_{A}/I_{B}≤0.03 (1)

Incidentally, from the viewpoint of more preferably suppressing the decomposition of Li₃PO₄, the upper limit value of the peak intensity ratio (I_{A}/I_{B}) can be set at 0.027 or less, can be set at 0.025 or less, and can be set at 0.02 or less. On the other hand, from the viewpoint of more surely preventing the gelation of the positive electrode mixture material layer 14, the lower limit value of the peak intensity ratio (I_{A}/I_{B}) can be set at 0.008 or more, can be set at 0.01 or more, can be set at 0.012 or more, and can be set at 0.015 or more.

### (3) Other Additives

The positive electrode mixture material layer 14 may include prescribed additives other than the essential components added therein. As such other additives, conventionally known materials can be used without particular restriction, and hence a detailed description thereon is omitted. As one example, for the purpose of improving the adhesion of the positive electrode mixture material layer 14 to the surface of the positive electrode collector 12, a binder can be added to the positive electrode mixture material layer 14. As the binder, a resin material commonly used as the binder of the nonaqueous electrolyte secondary battery can be used without particular restriction. Examples of such a binder may include carboxymethyl cellulose (CMC), polyvinylidene fluoride (PVdF), polyvinylidene chloride (PVdC), and polyethylene oxide (PEO). Further, other examples of the additive to the positive electrode mixture material layer 14 may include a conductive material. For the conductive material, a carbon material such as carbon black can be used.

Up to this point, a description has been given to the lithium ion battery in accordance with one embodiment of the present disclosure. Incidentally, the embodiment is merely an example, and the disclosure herein includes various modifications and changes of the embodiment.

### Test Example

Below, Test Example on the present disclosure will be described. Incidentally, the contents of Test Example described below is not intended to limit the present disclosure.

In the present Test Example, four kinds of lithium ion secondary batteries (samples 1 to 4) having different abundance ratios (I_{A}/I_{B}) of Li₃PO₄ and LiH₂PO₄ in the positive electrode mixture material layer were prepared, and the heating value upon overcharging each sample was evaluated.

### 1. Manufacturing of Each Sample

First, a mixture including a positive electrode active material, Li₃PO₄, LiH₂PO₄, a conductive material, and a binder mixed therein was manufactured. Then, the mixture was dispersed in a disperse medium, thereby preparing a paste-shaped positive electrode mixture material paste. Incidentally, in the present Test Example, as a positive electrode active material, lithium nickel cobalt manganese composite oxide (LiNi_{0.33}Co_{0.33}Mn_{0.33}O₂) was used. Further, acetylene black (AB) was used as a conductive material, and polyvinylidene fluoride (PVdF) was used as a binder. Then, water was used as the disperse medium for paste preparation. Then, the positive electrode mixture material paste was applied to each opposite surface of the positive electrode collector (aluminum foil), followed by drying/rolling, thereby manufacturing a sheet-shaped positive electrode. Incidentally, in the present Test Example, the amounts of the Li₃PO₄ and LiH₂PO₄ added were varied for each sample.

On the other hand, in the present Test Example, the negative electrodes with the same configuration were used for respective samples. The negative electrode used in the present Test Example is a sheet-shaped negative electrode obtained by applying a negative electrode mixture material layer on the surface of a negative electrode collector (foil). Incidentally, the negative electrode mixture material layer is obtained by drying/rolling a paste of a mixture of a negative electrode active material (graphite), a binder (styrene-butadiene copolymer (SBR)), and a thickener (carboxymethyl cellulose (CMC)).

Then, a positive electrode and a negative electrode were stacked via a separator, thereby forming a laminated body. The laminated body was wound, thereby manufacturing a wound electrode body. Then, the wound electrode body was accommodated with a nonaqueous electrolyte in a battery case, thereby constructing a battery assembly. The battery assembly was subjected to initial charging and discharging, and an aging treatment, thereby constructing a 4 V class lithium ion secondary battery for evaluation test. Incidentally, for the nonaqueous electrolyte, the one obtained by allowing a mixed solvent including EC, DMC, and EMC at a volume ratio of 3:4:3 to contain a support salt (LiPF₆) with a concentration of about 1 mol/L was used.

### 2. Overcharge Test

An overcharge test of compulsorily continuing charging at a constant current of 3 C up to 12 V under environment of 25° C. was conducted on the batteries for evaluation test (samples 1 to 4). Then, the measurement was carried out with the battery temperature after the voltage reached 12 V as the “battery temperature during overcharging”. The results are shown in Table 1. Incidentally, the battery temperature during overcharging in Table 1 is the relative value when the battery temperature of the sample 4 is assumed as 100%.

3. Measurement of Abundance Ratio of Li₃PO₄ and LiH₂PO₄

The battery for evaluation test of each sample was disassembled, to collect the positive electrode mixture material layer. The positive electrode mixture material layer was subjected to XRD analysis using an X-ray diffraction device (model: ULtima IV manufactured by Rigaku Corporation). Then, the peak intensity I_{B} in the vicinity of 22 cm⁻¹ and the peak intensity I_{A} in the vicinity of 27 cm⁻¹ in the XRD pattern of each sample were measured. Then, the ratio (I_{A}/I_{B}) of the peak intensity I_{A} to the peak intensity I_{B} was calculated as the “abundance ratio of Li₃PO₄ and LiH₂PO₄ in the positive electrode mixture material layer”. The results are shown in Table 1.

TABLE 1

| | | Battery temperature |
|---|---|---|
| | | during overcharging |
| | I_{A}/I_{B} | (%) |
| Sample 1 | 0.0002 | 107 |
| Sample 2 | 0.008 | 97 |
| Sample 3 | 0.03 | 98 |
| Sample 4 | 0 | 100 |
| | (No peak A) | |

As shown in Table 1, for each of the samples 1 to 3, the peak derived from LiH₂PO₄ was observed in the vicinity of 27 cm⁻¹, and I_{A}/I_{B} exceeded 0. Thus, for the samples 1 to 3 in which the presence of LiH₂PO₄ was observed with XRD, the gelation of the positive electrode mixture material layer was suppressed. On the other hand, for the sample 4 in which the presence of LiH₂PO₄ could not be observed with XRD, gelation of the positive electrode mixture material layer occurred. On the other hand, comparison among the battery temperatures of the samples 1 to 3 indicated that the heat generation during overcharging was preferably suppressed in the samples 2 and 3. The results have indicated as follows: LiH₂PO₄ is added in an amount enough to allow observation of the peak B derived from LiH₂PO₄ with XRD, and the positive electrode mixture material layer is formed so that the abundance proportion (I_{A}/I_{B}) of Li₃PO₄ and LiH₂PO₄ becomes 0.03 or less; this enables the construction of a lithium ion secondary battery capable of preferably suppressing the heat generation during overcharging.

Up to this point, the present disclosure was described in details, and the description is merely an example, and the technology disclosed herein includes various modifications and changes of the specific examples.

What is claimed is:

1. A nonaqueous electrolyte secondary battery comprising:
a positive electrode having a positive electrode mixture material layer;
a negative electrode; and
a nonaqueous electrolyte, wherein
the positive electrode has a region with an open voltage of 4.25 V (Li/Li⁺) or less in an operating range of the battery,
the positive electrode mixture material layer includes a positive electrode active material, trilithium phosphate, and lithium dihydrogenphosphate,
in an XRD pattern of the positive electrode mixture material layer, a peak intensity I_{A} detected in the vicinity of 27 cm⁻¹, and a peak intensity I_{B} detected in the vicinity of 22 cm⁻¹ satisfy expression (1) below:
0<I_{A}/I_{B}≤0.03 (1).

2. The nonaqueous electrolyte secondary battery according to claim 1, wherein the I_{A}/I_{B} is 0.008 or more.

3. The nonaqueous electrolyte secondary battery according to claim 1, wherein a content of the trilithium phosphate is 1 wt % to 15 wt %, with a total solid content mass of the positive electrode mixture material layer being 100 wt %.
